(19) United States
(12) Patent Application Publication
(10) Pub. No.: US 2009/0319399 A1
(43) Pub. Date: Dec. 24, 2009

(54) INVENTORY RACK WITH MEASURING MEANS

(76) Inventors: Frank V. Resta, Hillsborough, NJ (US); Paul Bamburak, Trenton, NJ (US)

Correspondence Address: NORRIS MCLAUGHLIN & MARCUS, P.A., 721 ROUTE 202-206, P.O.BOX 5933, BRIDGEWATER, NJ, 08807-5933, US

(21) Appl. No.: 12/306,142

(22) PCT Filed: Jun. 21, 2007
(86) PCT No.: PCT/US2007/071757

§ 371 Date: Aug. 18, 2009

Related U.S. Application Data
(60) Provisional application No. 60/815,409, filed on Jun. 21, 2006.

(51) Int. Cl. G06Q 10/00

(52) U.S. Cl. 705/28

(57) ABSTRACT

An inventory rack comprising a measuring means for inventory control. Also, methods of inventory control and theft deterrence with use of the inventory rack.

### CROSS-REFERENCE TO RELATED APPLICATIONS

This application claims the benefit of U.S. Provisional Application No. 60/815,409 filed Jun. 21, 2006 which is incorporated herein in its entirety by reference.

### BACKGROUND OF THE INVENTION

The invention pertains to an inventory rack comprising a measuring means, such as optical means or measuring devices, for inventory control. The invention further pertains to methods of inventory control and theft deterrence with use of the inventory rack.

### SUMMARY OF THE INVENTION

The inventory rack comprises one or more storage compartments for the storage and dispensing of items, including open and boxed items. Each storage compartment comprises measuring means, such as one or more optical means and/or one or more measuring devices. The optical means and/or measuring devices provide a numerical count of the number of items within each storage compartment or in all or any number of storage compartments at a given time. The optical means and/or measuring devices are generally capable of sensing when an item is present in, added to and/or removed from a storage compartment and, thus, is capable of providing a count of items remaining within the inventory rack. Accordingly, the inventory rack can provide a count of the total number of items removed from or added to the inventory rack over a given period of time or at a point in time, or a count of the total number of items present in the inventory rack and/or a storage compartment at a given period of time or point in time.

The method for inventory control comprises providing the inventory rack with the measuring means, such as the one or more optical means and/or one or more measuring devices and tallying the amount of items dispensed from the rack over a given time period or at a point in time. The method may further comprise digital or analog transmission of the data from the optical means and/or measuring device to a controller or processing unit. Data transmission may also include wired and wireless transmission.

The invention may also be useful as a theft deterrent device by providing a means to count the actual number of items placed into and removed from the inventory rack during a given time period or at a point in time, such as during the working shift of a clerk or other person having access to the inventory rack. Also, inventory control may be facilitated in that an on-site storage location, or an off-site warehouse or supplier, can be alerted of low inventory and the need to restock directly through data obtained from the optical means and/or measuring device rather than requiring a manual count and manual notification by the operator of the inventory rack.

### DESCRIPTION OF THE DRAWINGS

FIG. 1 is a front view of an inventory rack in accordance with an embodiment of the invention.

FIGS. 2A and 2B are perspective views of optical means in accordance with an embodiment of the invention.

FIG. 3 is a perspective view of a preferred optical means in accordance with an embodiment of the invention.

FIG. 4 is a partial elevation of an inventory rack in accordance with an embodiment of the invention with the optical means of FIG. 3 positioned within an inventory rack.

FIG. 5 is a partial elevation of an inventory rack in accordance with an embodiment of the invention showing a controller and a laptop for display of information.

FIGS. 6A-6D shows various display screens in accordance with embodiments of the invention.

FIG. 7 is a partial elevation of an inventory rack and measuring means in accordance with an embodiment of the invention comprising a spring loaded pusher having metal contacts and a conductive strip circuit board having one or more conductive strips.

### DETAILED DESCRIPTION OF THE INVENTION

The inventory rack generally comprises one or more storage compartments in which items, preferably packaged items, boxed items or items in cartons, can be stored for sale to customers. In a preferred embodiment of the invention, the inventory rack is used for storing and dispensing items at a point of sale, either through a sales clerk or other store employee or as part of a vending machine or as part of a point of sale display rack directly accessible by the consumer. Embodiments include display and storage of almost any type of product, generally presented to the consumer in a box, carton, wrapping, bag and the like, such as cigarette boxes and cartons, over the counter medicine, shaving blades, condoms, lottery tickets, razors, razor blades, chewing gum, candy, sport and entertainment card packs, perfume, packaged foods, novelties, and the like, to name some of the types of items that may be stored and/or displayed in the inventory rack. For example, the inventory rack can be used in a store, such as a convenience store, for storage and dispensing cigarette packs and/or cartons for sale, such as an overhead or behind the counter inventory rack from which a sales clerk dispenses packs of cigarettes for sale to customers. Because the inventory rack comprises optical means and/or measuring devices that can tally the insertion and removal of items into and from the inventory rack, counting out sales at the end of a work shift is facilitated because the inventory rack eliminates the need to physically count each item in the inventory rack at the beginning and end of each work shift.

Retailers often carry a significant amount of inventory in areas other than the point of sale. Thus, in addition to the “front room” uses of the inventory rack for such things as point of sale purchases by a consumer in the public areas of a store, the inventory rack may also be used in the “back room” such as in a storage area or warehouse where items are held in storage or inventory prior to being placed into “front room” inventory racks for direct sale to consumers. For example, the measuring means, such as the optical means or measuring device, may be used in inventory racks or storage systems in “back room” storage areas or warehouses for inventory control. For example the use of the measuring means and/or inventory rack in “back room” operations could allow for communication with a supplier or central warehouse to allow for restocking of inventory supply without the need for a person to physically contact the supplier or central warehouse for restocking.

An embodiment of the invention comprises measuring means involving the use of one or more sensors, such as an infrared reflective photo sensor, which can detect the presence or absence of an item within the inventory rack and/or a storage compartment. The sensors may be located within the inventory rack such that each sensor corresponds to a location of an item within the inventory rack. The data regarding the presence or absence of an item at a particular location can then be correlated to a tally of the total number of items in the inventory rack and/or storage compartment using commercially available software tools which compile a tally of items and sets up a display of the items such as on a monitoring screen of a laptop or CPU. The data may be processed in a controller or processor, and/or in a laptop or CPU, to display the total number of items in the inventory rack at any time, the total number of items in any storage compartment of the inventory rack and date and time of sale based on removal of an item registered by the photo sensors based on detecting an absence of an item in a location of the inventory rack or storage compartment when an item is removed. The controller or processor may have an integrated display or the controller or processor may be a separate piece of equipment from the controller which may feed data to a display which could be a monitor, television, electronic board or a laptop computer (having an integrated monitor or display). Software for computing the data and display of information can be developed using software tools such as MICROSOFT® Word, MICROSOFT® Visual Basic, and MICROSOFTO Excel.

In another embodiment, the measuring means counts the number of items, packages or cartons in the inventory rack by 1) having data as to, at least, the individual dimension of an individual item, package or container in a storage compartment, such as the longitudinal length (i.e. the length in the longitudinal direction such as the direction from the top to the bottom of the inventory rack and/or storage compartment) within a storage compartment of the inventory rack, 2) measuring the cumulative length of items, packages or cartons and 3) determining total number of packages, items, or cartons in a storage compartment by processing the algorithm of cumulative length of items, packages or cartons in a storage compartment by the individual length of the item, package or carton. For example based on the length of each product, i.e. the dimension of the product in a longitudinal direction in a storage compartment, dividing the cumulative length of the total number of items in a storage compartment by the length of an individual product in each storage compartment (i.e. the longitudinal length), the total number of product is obtained. Commercially available software capable of making such calculations may be used. Removal of a product will decrease the length which is detected by the optical sensor and/or measuring device, and registered as removal of an item from the inventory rack. Conversely, addition of items will increase the length which is detected by the optical sensor and/or measuring device and registered as an addition of an item. By measuring the length of items it is not necessary to modify the dimensions or contents or add any markings or devices to the items.

The measuring means may also comprise a system that measures/detects the position of an item, such as a product or a product holder, in the inventory rack. For example, in a drawer type inventory rack or storage rack a slidable product pusher, such as a spring loaded pusher, may be used to move/urge product to the front of the drawer thereby allowing easy access to the product. The position of the slidable product pusher may be measured/sensed. The detected position of the product pusher in combination with knowledge of the dimensions of the product being stored in the inventory storage rack may be used to determine the total number of product within one or more storage compartments of an inventory rack or storage rack.

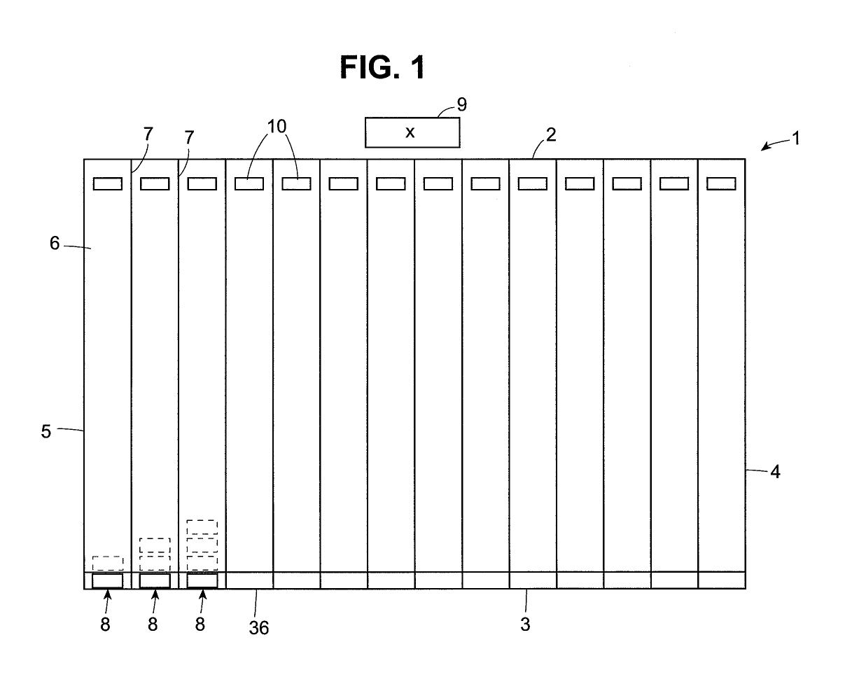

FIG. 1 depicts an embodiment of the invention wherein the inventory rack is in a particular configuration, such as for the retail sale of cigarettes in individual packages or cartons. It is understood, however, that the inventory rack may be configured for storage and dispensing of any type, shape, configuration or number of items and may be a component of a means for dispensing items, such as a vending machine or as part of a point of sale display rack directly accessible to customers. Further, as discussed above, the measuring means and/or inventory rack can be used in “back room” operations.

In the embodiment shown in FIG. 1, the inventory rack 1 comprises a top 2 and an opposing bottom 3, a first side 4 and mutually opposing second side 5. The inventory rack also comprises one or more storage compartments 6. The storage compartments 6 are defined within the inventory rack by one or more separators 7 which generally are perpendicular to the top 2 and bottom 3. The inventory rack may further comprise a front (not shown) and a back (not shown). The back may be a solid piece of material extending from the top to the bottom and from the first side to the second side, or the back may be a discontinuous piece of material such as a wire arrangement, mesh, or other means to prevent the items from falling from the storage compartments. The front may be a solid piece of material extending from the top to the bottom and from the first side to the second side, or the front may be a discontinuous piece of material such as a wire arrangement, mesh, or other means to prevent the items from falling out of the storage compartments. The front, however, preferably has a top gap proximate to the top 2 to enable items to be inserted into each storage compartment, and a bottom gap 36 proximate to the bottom 3 to enable items to be removed from each storage compartment.

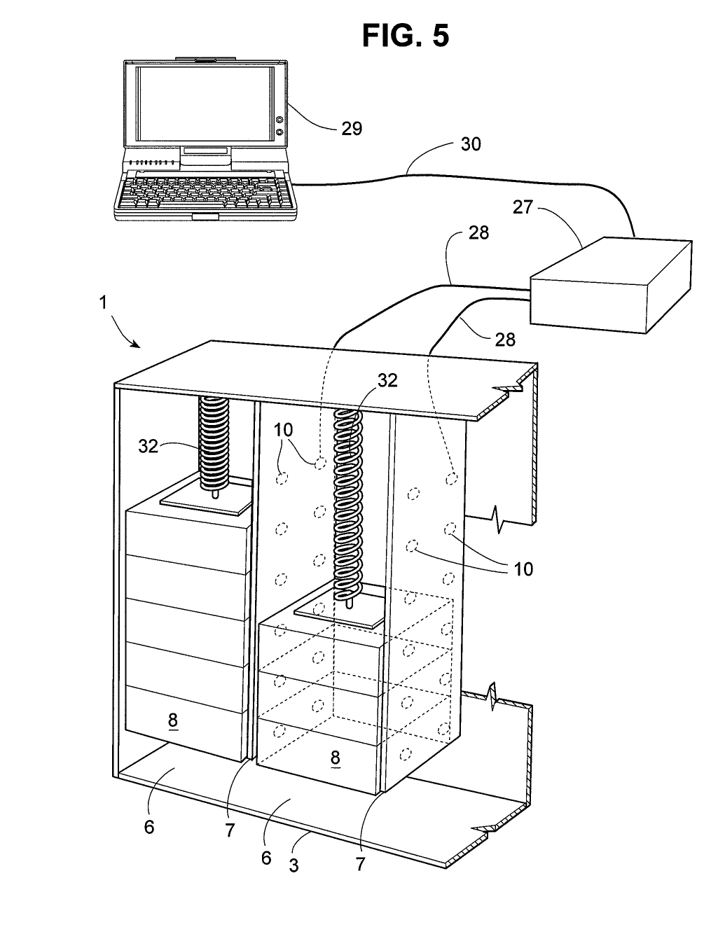

FIG. 1 shows items 8, such as cigarette packages or cartons, within several of the storage compartments. The front and back are separated by a depth and the separators are spaced at a width, generally corresponding proximately to one or more dimensions of the item(s) 8 to be stored in the inventory rack 1. The separators 7 may be removably affixed to the inventory rack to allow for flexibility in the size of items, such as different types and/or sizes of packages or goods stored in or dispensed from the inventory rack. As an item 8 is removed from the inventory rack 1, the item immediately above the removed item will move toward the bottom 3 of the inventory rack 1. This movement may occur by force of gravity or by some movement means, such as a device which urges the item towards the bottom as items are moved from the inventory rack. For example, a tension device, such as a spring loaded arm, may be used to urge items forward, particularly in racks where items are stored horizontally such that gravity will not completely move the items. FIG. 5 shows a storage compartment in an embodiment of the invention having a tension device, such as a spring 32, which urges items 8 towards the bottom 3 of the inventory rack 1. The tension device is an optional component of the inventory rack.

The inventory rack optionally comprises a counter 9 which tallies the number of items inserted into and/or removed from the inventory rack with the use of the measuring means, i.e., optical means or measuring device, 10 within each storage compartment. Although the optical means or measuring device is shown in FIG. 1 at one location in the inventory rack, for example at the top of the rack opposite where the items are removed from the rack, the optical means or measuring device may be located at any position within the inventory rack. The measuring means, i.e., optical means or measuring device, 10 is capable of counting the number of items in each storage compartment within the inventory rack using the methods discussed above and reports data to a controller, i.e. processing unit, which converts the data into an integer which can then send a signal to the counter 9 with a tally of all the items in the inventory rack 1 and as discussed above can process data for display on a computer monitor. The controller may include a central controller and/or remote controller. In the embodiment of the invention depicted in the drawings, the inventory rack has one counter; however, inventory racks with more than one counter, such as a number of counters equal to the number of storage compartments, and inventory racks with no counters, are within the scope of the invention. The tally of items in each storage compartment may be displayed on the counters or may be displayed in the monitor of a controller, like a laptop and/or CPU.

The controller in any embodiment may be a central server or a local laptop or CPU. In addition to processing the inventory count for display on the inventory rack, the controller or processor may retain a record of sales and inventory and/or collect other relevant data, such as the time of sale, identification of particular products or sizes, expiration date data, residence time on the inventory rack, frequency of sale and the like. For example, the measuring device can be used to determine if the inventory rack is being properly restocked at appropriate time periods. The data may be sent to the controller by hard wire or by any means of wireless communication, including radio wave, wi-fi or infrared communication and in turn, the controller may, transmit some or all of the data to third-parties, such as suppliers, manufacturers or central warehouse facilities by hard wire, such as a telephone line, or by wireless communication. The data also may be accessed or used by any number of persons internal to the operator of the inventory rack, such as a salesperson, store clerk, manager or buyer and the like. The inventory rack provides real-time counting of inventory, inventory control, inventory monitoring, inventory ordering and the like.

Optical means for sensing the number of items in one or more storage compartments may include use of reflective or thru beam optical sensors aligned with each pack, with the output of each sensor a direct indication of the number of items. Also, the use of random staggered optical sensors to accommodate items of different sizes is within the scope of the invention which may preclude or decrease the possibility of a sensor giving a false reading, for example by sensing at an edge of an item of product, i.e. one or more containers or boxes within one or more storage compartments of the inventory rack. Staggered sensors are also useful when items having different sizes are within storage compartments in the inventory rack. The staggered sensors compensate for the different sizes and by inputting the type of item into the controller, the inventory rack determines which sensors to read and/or when to skip one sensor for the next one to compensate for different sized items resulting in misalignment between items and sensors. The optical means, or any measuring means used in the inventory rack, may be calibrated to compensate for variations in, for example, product size, shape, color, reflectivity, material and the like.

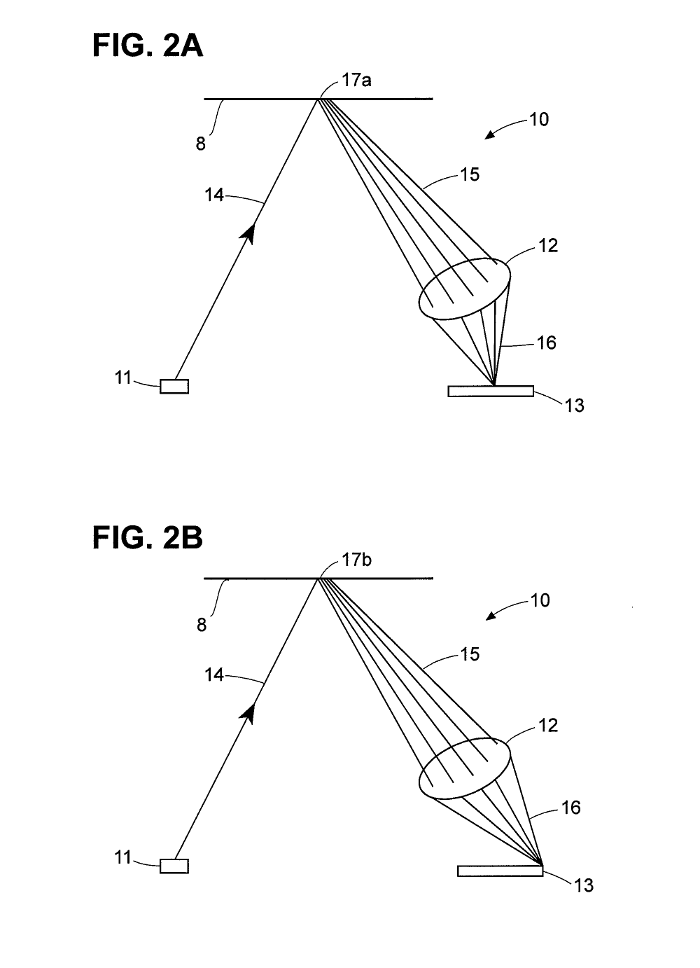

In the embodiment of the invention shown in FIGS. 2A and 2B, the optical means 10 comprises a light source 11, a lens 12, which may be optional, and a sensor 13. In this embodiment, the light source 11, emits a light beam 14 in the direction of an item 8 moving within a storage compartment 6 of the inventory rack 1. The light beam 14 may be laser or LED based and is directed to the package 8 (or the optical spot 17a and 17b) which reflects the light beam 14 from the optical spot (17a, 17b) on the item 8 sending one or more reflected beams 15 to the sensor 13. The optical spot (17a, 17b) should be understood as the location of the item 8 where the light beam 14 hits the item 8. The sensor may be a CCD (Charge Coupled Device) array interface, which senses the reflected light beam 14. In the embodiment of FIGS. 2A and 2B, the optical means comprises a lens 12 which is preferably convex located at a point between the target and sensor such that the lens focuses the one or more reflected beams 15 into one or more focused beams 16 at the sensor 13. When the light is reflected, the reflected beams 15 move in a plurality of directions and the lens will take these unfocused reflected beams and focus them for the sensor.

As shown in FIGS. 2A and 2B, as the target being sensed moves closer to the sensor in the storage compartment, the location of the reflection of the light beam 14 within the storage compartment, and, thus, the optical spot (17a, 17b), moves which will be detected by the sensor through triangulation, i.e., optical triangulation. That is the sensor may detect optical spot 17a (in FIG. 2A) and then, when one or more packages are removed, it senses optical spot 17b (in FIG. 2B) and the difference in location of optical spot 17a and 17b. The data from the sensor is sent to a processing unit which applying commercially available software calculates the distance to the target, such as the distance of the optical spot to the sensor which is effectively a measure of the cumulative length at each optical spot. This data is converted to an integer amount of item remaining in a storage compartment by software which calculates the number of items by factoring the cumulative length of the items by the longitudinal length of each individual item as discussed above. Commercially available software capable of making such calculations may be used. As product is removed from the storage compartment(s) within the inventory rack, the optical means will sense the movement of packages within the storage compartment and recalculate the number of packages within the storage compartment based on the changes in cumulative length factored by the longitudinal length of each item in the storage compartment. Accordingly, the optical means allows for a running tally of the amount of product within each storage compartment and/or the entire inventory rack.

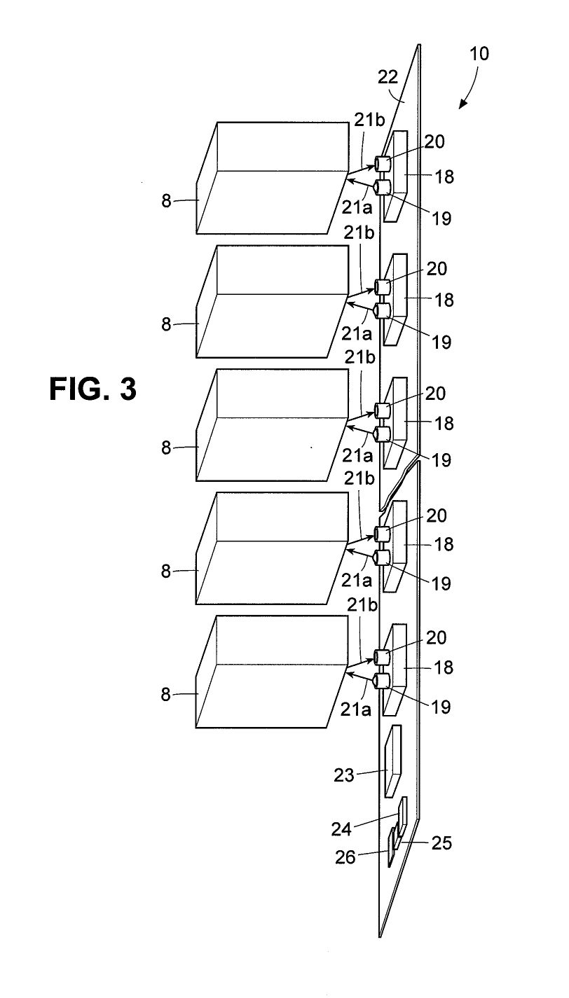

FIG. 3 shows a preferred optical means 10 for use in the inventory rack. Located adjacent to each item 8 to be counted is an infrared reflective photo sensor 18 which comprises an infrared light source (emitter or source) 19 and an infrared sensitive switch (detector or sensor) 20. A small single integrated circuit (IC) computer chip known as a microcontroller 23 is provided to turn on the emitters one at a time. When the emitter 19 is on, a beam of infrared light will be projected toward one of the items 8. If the item 8 is present in front of the emitter 19 the light will be reflected back toward the respective detector 20. The light is shown as 21a for the emitted light and 21b for the reflected light with the arrows showing the travel direction of the light. The microcontroller 23 will measure the output voltage from the detector and depending on the value of the voltage determines whether a package is present at that location or not. The microcontroller sequentially reads all of the sensors on its circuit board and keeps a count in its memory of the number of packages that were present. The microcontroller and a set of sensors are mounted on a small circuit board 22 which can be mounted in a row or storage compartment of the inventory rack which holds the packages to be counted, or there may be one circuit board mounted for multiple rows or storage compartments within an inventory rack.

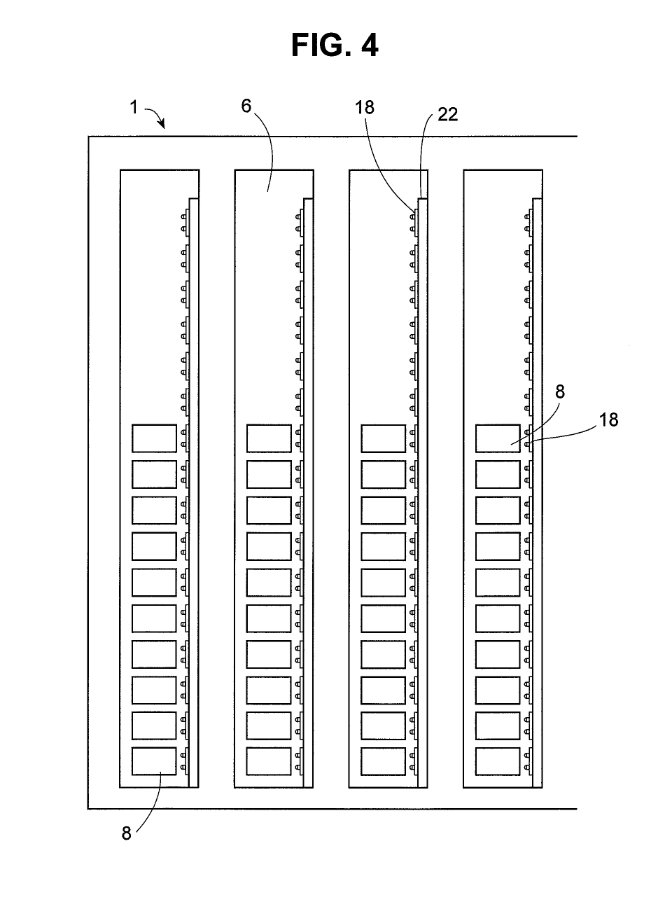

FIG. 4 shows circuit boards 22 positioned within storage compartments 6 of the inventory rack 1. The circuit board 22 is arranged so that infrared photo reflective sensors 18 are aligned with an item 8 or locations within a storage compartment where an item may be located. The presence or absence of an item 8 aligned with the infrared photo reflective sensor 18 is detected by the infrared photo reflective sensor 18 which allows a tally of items 8 in each storage compartment 6 and/or the entire inventory rack 1.

Each of the circuit boards 22 is connected together with a transcriber, such as with a connection known as a serial RS485 link. This link allows a computer or other controller to read the count as determined by each individual circuit board. As shown in FIG. 3, the circuit board may comprise a wireless data communication device, such as a wireless transcriber, 24, a port for wire communications 25 to a controller and a power connection port 26. To distinguish the circuit boards apart they are all given a numerical address, which is stored in the memory of the microcontroller. The controller sends serial signal to all of the circuit boards simultaneously. This serial signal specifies the address of the circuit board which is to respond with its item count. The specified circuit board sends its count information, using the serial link, to the controller. The controller reads the count information from all of the circuit boards, adds them to get the total package count, and shows this information on a display. The software for processing the data can be developed using conventional theories with basic software tools, such as MICROSOFT® Word, MICROSOFT® Visual Basic, and MICROSOFT® Excel.

In an embodiment of the invention, each circuit board has a microcontroller, a transcriber, one or more optical sensors, and a power supply circuit. Each inventory rack may comprise one or more of these circuit boards. Further data, as discussed herein, may also be supplied from the circuit board to the controller.

In an embodiment, each circuit board has previously been assigned a unique address number. The controller sends a command with a unique address embedded over the serial bus for a given circuit board to report its count information. The respective circuit board responds with its count data. The controller repeats this sequence changing the address until the count information has been obtained from all the boards in a system. The procedure may be repeated continuously to maintain a real time count of all items in a system. Wireless methods can also be used to communicate the information between the circuit boards and the controller.

The microcontroller sequentially turns on the emitter of each sensor and the emitter on the microcontroller reads the output voltage of the respective sensor. From this value the dark current value of the respective sensor is subtracted resulting in output voltage proportional to the light reflected from an item which might be present in front of the sensor. If this voltage exceeds a threshold value an item is determined to be at that location.

To eliminate the effect of ambient lighting conditions, the microcontroller on each board may also read the output of its detectors with the infrared emitters off. The voltage read in this emitter off condition will be subtracted by the microcontroller to determine the true output voltage of the detectors and eliminate false package counts.

In an embodiment, the controller may determine whether an item 8 in the inventory rack 1 is improperly positioned within the storage compartment 6. For example, after receiving the count information from each circuit, the controller may look for any discontinuities in the activation of sensors 18 on each circuit board 22. That is, the controller may determine whether a non-activated sensor 18 on the board 22 is located between two activated sensors 18, thereby suggesting that an item 8 has been properly placed in the storage compartment 6 or otherwise improperly positioned within the storage compartment. The controller may provide an indicator on the display, or otherwise, to notify a user of such an occurrence.

FIG. 5 illustrates the overall system in an embodiment of the invention. The system comprises an inventory rack 1 having therein items 8 within one or more storage compartments 6 defined by separators 7. In this embodiment, the inventory rack 1 comprises measuring means 10 at the separators 7. The measuring means may be any of the optical means or measuring devices described herein. The measuring means 10 are connected to a controller 27 through connectors 28, such as a serial RS485 link. Data from the controller 27 is sent through a wire connection 30 to a display 29, which is this embodiment is a laptop computer, however the display may be any type of device which displays information. Further, the wire connection 30 is optional in that wireless communication between controller 27 and display 29 is within the scope of the invention as well as wireless communication between the measuring means and controller. One or more series of measuring means may be tied to a particular controller and the system may comprise more than one controller. For example, in an embodiment where the measuring means is an infrared photo sensor or a component of the circuit board 22 described above a plurality of circuit boards, such as up to 10 circuit boards, can be tied to a controller through a plurality of connectors, such as hard wires or wireless modules, preferably one for each circuit board, and the system may comprise a plurality of controllers which each provide data or information to one or more displays. In a further embodiment, the plurality of controllers may provide data to a central controller which provides data or information to one or more displays.

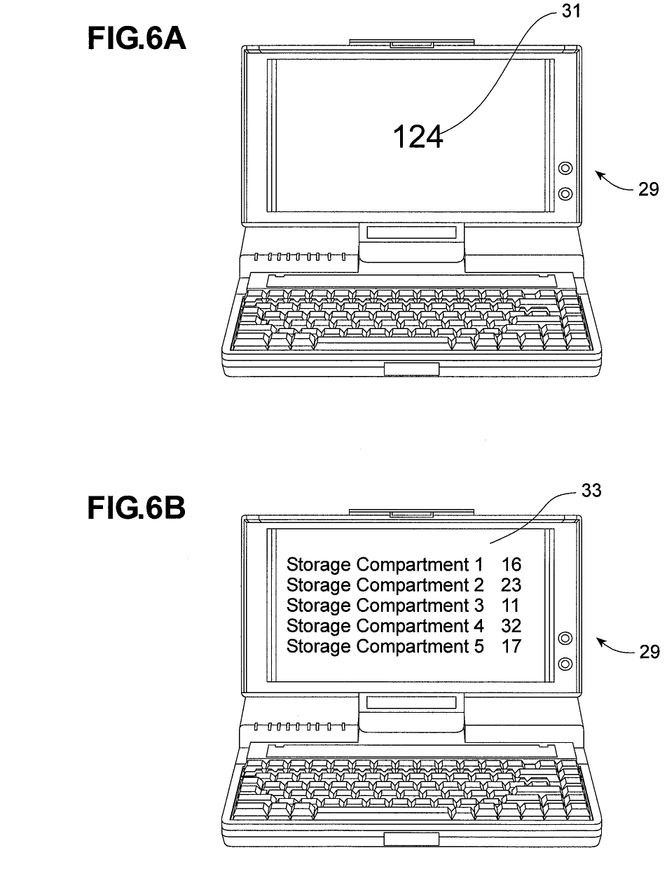

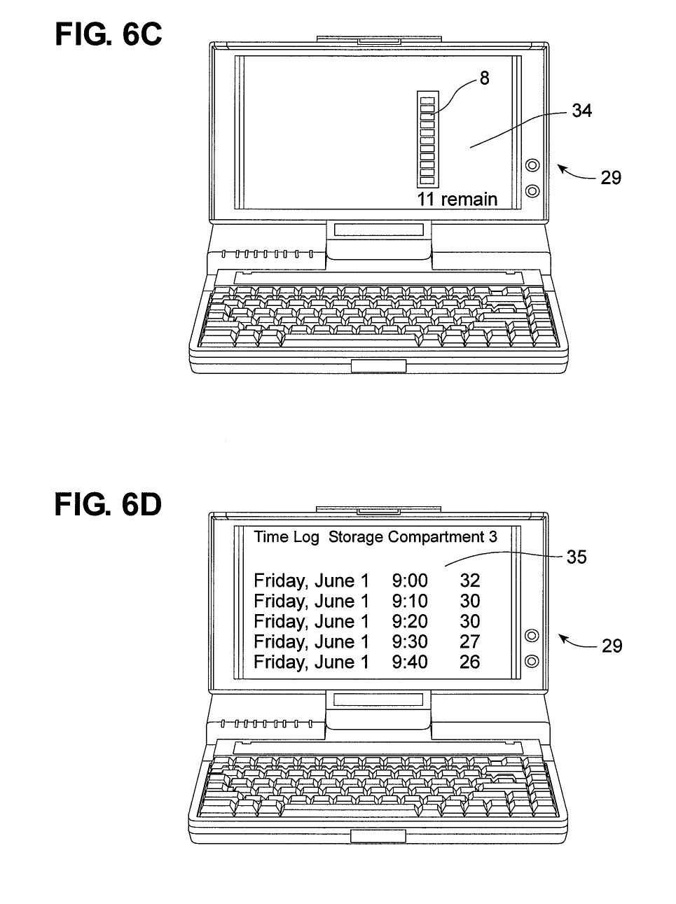

FIGS. 6A-6D show the various screens of data that can be provided to the display 29, such as a laptop. The screen in FIG. 6A shows a total count 31 of the items 8 in the entire inventory rack and the screen on FIG. 6B provides a storage compartment list display 33 of the number of items 8 in each storage compartment of the inventory rack. In an embodiment, the user may interface with the controller 27, particularly the screen of FIG. 6B to obtain the screen shown in FIG. 6C which provides a graphical representation 34 of the number of items 8 in an individual storage compartment within the inventory rack. In a further embodiment, a time log of items at a given period of time can be displayed. For example, the controller can keep a log for up to 7 to 10 days of the number of items in the inventory rack at a given time such as every 10 minutes, 15 minutes, 20 minutes and the like and display this information. FIG. 6D illustrates a typical time log display 35 in accordance with an embodiment of the invention. The display screens shown in FIGS. 6A-6D are illustrative of typical data that may be displayed with the inventory rack and systems described herein and variations in both the content and style of displays are within the scope of the invention.

Other types of measuring means may include, for example, certain measuring devices used in mechanical systems such as shelf systems with one or more spring loaded pushers. In such shelf systems with spring loaded pusher(s), the location of the pusher can be measured with a series of metal contacts mounted to the pusher which makes contact with traces on a circuit board giving a digital indication of the position of the pusher to act as a sensing device to extrapolate the number of items in the inventory rack and/or storage compartment. Other sensing devices may comprise determining the position of the pusher by magnetic or capacitive proximity sensor, a line resistive element with the wiper mounted to the moving part of the pusher or by the measurement of a change in the electrical resistance of the spring to infer the position of the pusher. Depending on the mechanical configuration of the shelf system, a single circuit board can be used to sense two storage compartments of items. This can be accomplished by placing the circuit board between two storage compartments and having the sensing devices, such as those discussed above, on both sides of the circuit board and it may be possible to measure a plurality of storage compartments, or product, i.e. one or more, two or more, three or more, four or more and the like, with a single circuit board by adding further sensing devices to the circuit board. It should be understood that the inventory rack with measuring devices based upon these mechanical sensing devices may have the same or similar configuration with respect to the location of the sensors as shown in the drawings.

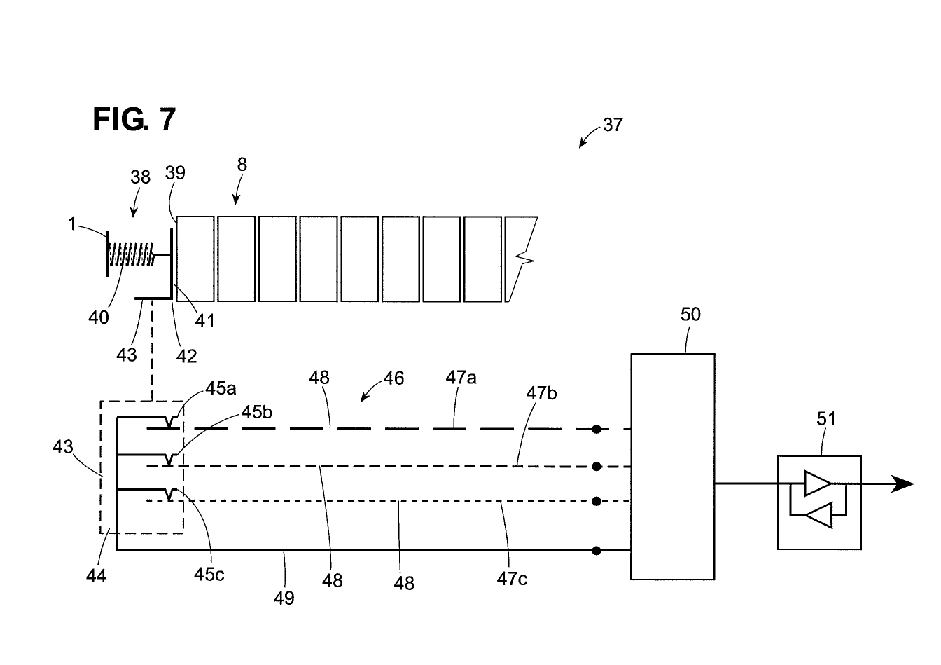

In embodiments of the invention the inventory rack is equipped with spring loaded pushers comprising metal contacts which interface with a circuit board having one or more conductive strips, preferably discontinuous conductive strips. The circuit board is adjacent to the location in a storage compartment where items are stored and/or displayed with the metal contacts aligned with and touching the conductive strips. Based on the location on the one or more conductive strips that the metal contacts are touching, the distance of the spring loaded pusher to a reference point, such as an end of the circuit board or storage compartment, is determined and based on this location a controller and/or microcontroller having data as to the dimensions of each individual item calculates the number of items in the storage compartment and/or inventory rack by processing the algorithm of the distance of the metal contacts of the spring loaded pusher to the reference point by the dimension of an individual item, such as the width of the item along the length of the circuit board as shown in FIG. 7. As product is removed from the storage compartment the spring loaded pusher moves urging the items in a direction and as the spring loaded pusher moves the location of metal contact with the conductive strip changes and the controller and/or microcontroller can recalculate the number of items in the storage compartment and/or inventory rack. The data on the number of items in one or more storage compartments and/or the inventory rack, and also other data as discussed herein, can be processed by a microcontroller and/or controller and displayed as discussed herein using the devices and equipment disclosed with respect to the other embodiments of the invention.

An embodiment 37 comprising a spring loaded pusher 38 is shown in FIG. 7. In this embodiment, the spring loaded pusher 38 is located adjacent to one or more items 8 within a storage compartment of an inventory rack 1. As shown in FIG. 7, the spring loaded pusher 38 is adjacent to an item 8 at a terminal end 39 of a plurality of items within the storage compartment. The spring loaded pusher 38 comprises a spring 40 attached at one end to the inventory rack 1 and at another end to a plate 41 which is generally in communication with an item 8 at the terminal end 39. In the embodiment of the invention shown in FIG. 7, the plate 41 comprises at least one side 42 and adjacent to the side 42 is a side flange 43 having at least a bottom 44. The spring loaded pusher comprises one or more metal contacts 45 which may be located anywhere on the spring loaded pusher 38 so long as they make contact with the circuit board. In the embodiment of the invention shown in FIG. 7, however, the spring loaded pusher 38 comprises three metal contacts (45a, 45b, and 45c) at the bottom 44 of the slide flange 43. The embodiment further comprises a conductive strip circuit board 46 comprising one or more conductive strips 47, preferably the number of conductive strips 47 is equal to the number of metal contacts 45. In the embodiment of the invention shown in FIG. 7 the conductive strip circuit board 46 comprises three conductive strips (47a, 47b, and 47c). The conductive strips preferably are discontinuous in that there are one or more gaps 48 along the conductive strip 47. Each metal contact 45 is aligned with and touching a conductive strip 47. As the items are removed from and/or placed into the storage compartment, the spring loaded pusher 38 will move changing the location of the metal contact 45 on the conductive strip 47. Further there is a central signal line 49 which connects each of the metal contacts 45 with a microcontroller 50 and the microcontroller 50 may selectively activate one or more of the metal contacts 45. Each conductive strip 47 communicates with the microcontroller 50 and based on the location of the metal contact on the conductive strip data as to the number of items within the storage compartment and/or inventory rack based on the algorithm described above can be determined. In the embodiment of the invention shown in FIG. 7, the microcontroller 50 provides data to the controller 51 which functions as described herein with regard to other embodiments of the invention, such as sending data to a display, like a computer monitor or laptop.

In the embodiment of the invention shown in FIG. 1, the optical means or a measuring device 10 may comprise the light source, lens and sensor as shown in FIG. 2 which are located proximate to the top 2 of the inventory rack. In this embodiment, each storage compartment 6 has an optical means. Each light source emits a light beam within its respective storage compartment 6 which is reflected off items in the storage compartment to generate one or more reflected beams which are focused by the lens to generate one or more focused beams which are received by the sensor enabling inventory counts of items in each storage compartment, as well as the inventory counts for the entire inventory rack. In an embodiment of the invention, the optical means may be within a casing about the same size and dimension as the individual packages as cartons held in the inventory rack. The optical means or measuring devices 10 may be any of the devices discussed herein such as the measuring devices discussed above for shelf systems with spring loaded pushers.

Because the measuring means, i.e. optical means or measuring device, generates data that can provide a tally of the amount of product removed from the inventory rack, the measuring means may be used in a method of inventory control wherein the amount of inventory sold over a period of time is tallied through the inventory rack, in particular, from data generated through the measuring means, i.e., optical means or measuring device, and the tally may be compared to sales receipts for that period of time to ascertain if the amount of sale is equal to the amount of product sold or obtained from the data generated by the measuring means.

Also, data regarding the amount of product in the inventory rack may be sent to warehouses, suppliers or other providers of goods to inform them of inventory flow and re-stocking needs without the need for a third-party, such as a buyer or store owner, placing an order for re-stocking of goods for the inventory rack.

The data provided to product suppliers may be used for suppliers' inventory incentives to retailers. For example, the supplier may provide incentives to retailers, such as product rebates, if the retailer maintains a certain level of inventory at any given time. The data generated by the inventory rack and sent to the product supplier may be used to verify inventory levels and, thus, facilitate retailer incentives.

Also, the inventory rack may include an electronic display that may render promotional information, product price, product information, and the like. The electronic display may receive incoming data from a product supplier, such as an offer to change the sales promotion for a particular item. For example, the product supplier may monitor the inventory levels at the retailer via the inventory rack. If inventory is too high, the product supplier may lower the displayed price remotely in an effort to facilitate product sales. Conversely, if the inventory is too low or the rate of sale is very high, the product supplier may increase the price remotely to increase profit margins.

The inventory rack and method of inventory control using the inventory rack is particularly useful for the sale of cigarettes, cigars or other tobacco products. Presently, theft deterrence for such items relies upon manual counting of inventory at the start and end of each work shift with a comparison of this manual count to sale receipts during the work shift. This manual count mode may also be applied in commercial settings with other types of items that can be stored and/or displayed in the inventory rack. This manual count is time consuming and subject to error. With the inventory rack, a count of product sold during the work shift can be obtained from the data generated through the measuring means, i.e., the optical means or measuring device, which can be readily compared to sales figures thus eliminating the manual count at the beginning and end of a work shift.

The inventory rack will facilitate inventory control, product ordering and enhance point-of-sales display. For example, by allowing product manufacturers and suppliers access to inventory data (such as allowing cigarette manufacturers access to inventory of a store in real time) the manufacturer can send new shipments when needed which should diminish situations when a desired item goes out of stock because the need for restocking has gone unnoticed by store personnel or there is delay in a store employee communicating the need for restocking to the manufacturer or supplier. Sales can be enhanced in that advertisement or sales prices displayed on an electronic advertising display that may be associated with the inventory rack can be changed remotely by the product manufacturer, such as changes in advertised sales price based sales volume or promotion.

The data may be time-stamped which also facilitates inventory control. Thus, the inventory rack may enable retailers to identify peak purchase times, helping retailers to better plan restocking scheduling and employee staffing. In addition, the data generated by the inventory rack may enable the retailer to ensure that employees are re-stocking inventory at proper times. For example, the retailer may use the data to verify that an employee is stocking the shelf at the beginning of a shift, thereby reducing the likelihood of lost sales due to depleted inventory. The time-stamped data may also assist retailers in identifying spot and/or recurring product losses. For example, the data may indicate that a particular product is always short during a particular shift. Such information may allow the retailer to focus on the employees or customers that are in the store during that shift.

Also, the time stamped data may enable the retailer to account for the freshness of a product. For example, product suppliers may require retailers to remove products after a predetermined date to reduce the likelihood of a customer purchasing a stale or otherwise less than satisfactory product. Using the data generated by the inventory rack, the retailer may be able to identify when inventory was last added to the rack and the rate at which inventory has been sold from the rack. If the sales rate is too low and/or the inventory remaining in the rack is too high after a certain date, the retailer may pull the products from the rack and return them to the supplier.

Pricing and embodiments of the inventory rack may provide for differentiating between different products that may be displayed within the inventory rack. For example, a particular storage compartment within the inventory rack may be designated as holding a particular product. Thus, the retailer may be able to determine if one brand of cigarettes, for example, is selling better than another. Such information may allow the retailer to achieve a more balanced inventory.

Indeed, because of the interoperability of the inventory rack with providing data to a manufacturer or supplier, particularly with wireless communication, embodiments of the inventory rack may be used with remote dispensing devices, such as a vending machine at a remote location like a highway rest stop, third-party office or park, to name a few, which enables the owner of the vending machine, supplier of materials to the vending machine and manufacturers, real time inventory information and control mechanisms to facilitate restocking of vending machines at remote locations without physical stock checking and also potential modification of pricing without the need for a person to attend to the remote vending machine to change price displays.

Theft deterrence is also enhanced in that the inventory rack allows ease of access and interoperability with other security systems. For example, the inventory counting and control system of the inventory rack may be tied to the store security system (e.g., the surveillance cameras at a store). That is, each time an item or predetermined numbers of items are removed from the inventory rack, the inventory rack may cause the surveillance cameras at a retail location to focus on the inventory rack. Along with the time stamped data, this may enable the retailer to identify who removed the items and when the items were removed.

The inventory rack comprises one or more storage compartments for holding one or more items and one or more measuring means, i.e., optical means and/or measuring devices, which are capable of sensing the number of items in the one or more storage compartments. In an embodiment, the optical means uses triangulation to develop data from which the number of items inserted, stored and/or removed from the inventory rack can be determined. The optical means of the inventory rack may comprise a light source and a sensor wherein the light source emits a light beam that is directed to a package within a storage compartment that is reflected by the package to create one or more reflected beams which are received by a sensor. The optical means may further comprise a lens which receives the reflected beams and focuses the reflected beams into one or more focused beams which are received by the sensor. The sensor generates data on distance of the package to the sensor that can be converted into an integer number of packages, and may be used in conjunction with a microprocessor and/or controller. The source that emits a light beam may be an infrared light source and the sensor may be an infrared sensitive switch.

The invention further pertains to a method for inventory control comprising the steps of a) providing the inventory rack described herein having, measuring means, such as optical means or measuring device comprising a source and a sensor and the source produces one or more light beams, including infrared beams, b) inserting and/or removing items from the inventory rack such that the light beams are reflected by the item to generate one or more reflected beams that are received by the source and c) determining the number of items in all or some storage compartments within the inventory rack at a given time, including methods wherein the number of items in all or some storage compartments is determined by data generated through optical triangulation or by a microprocessor. The invention also concerns a method wherein the optical means further comprises a lens which receives the reflected beams and focuses the reflected beams into one or more focused beams and the focused beams are received by the sensor.

What is claimed is:

1. An inventory rack for storage and display of items comprising measuring means for determining the number of items in the inventory rack.

2. The inventory rack of claim 1 wherein the measuring means comprises a light source and a sensor.

3. The inventory rack of claim 1 wherein the measuring means comprises an infrared light source, a reflective photo sensor, an infrared sensitive switch and a microcontroller.

4. The inventory rack of claim 1 further comprising one or more spring loaded pushers having a spring wherein the measuring means comprises metal contacts mounted to the one or more spring loaded pushers, magnetic proximity sensors, capacitive proximity sensors, a line resistive element comprising a wiper mounted to the one or more spring loaded pushers or measurement of a change in the electrical resistance of the spring.

5. A method of inventory control comprising the steps of providing the inventory rack of claim 1, inserting and removing items from the inventory rack and at a given time determining the number of items in one or more storage compartments of the inventory rack with the measuring means.
